(19) United States
(12) Patent Application Publication
(10) Pub. No.: US 2018/0227898 A1
(43) Pub. Date: Aug. 9, 2018

(54) METHOD AND APPARATUS FOR BEAM SEARCHING AND MANAGEMENT IN WIRELESS COMMUNICATION SYSTEM

(71) Applicant: Samsung Electronics Co., Ltd., Suwon-si (KR)

(72) Inventors: Jeehwan NOH, Suwon-si (KR); Taeyoung KIM, Seoul (KR); Jiyun SEOL, Seongnam-si (KR); Hyunil YOO, Suwon-si (KR)

(21) Appl. No.: 15/883,384

(22) Filed: Jan. 30, 2018

(30) Foreign Application Priority Data
Feb. 6, 2017 (KR) 10-2017-0016367

(51) Int. Cl. H04W 72/04; H04W 76/10

(52) U.S. Cl. CPC H04W 72/046; H04W 76/10

(57) ABSTRACT

The present disclosure relates to a pre-5th-Generation (5G) or 5G communication system to be provided for supporting higher data rates Beyond 4th-Generation (4G) communication system such as Long Term Evolution (LTE). A method for beam management of a base station and an apparatus therefor are provided. The method includes receiving information on whether beam correspondence (BC) of a terminal is established, identifying information on whether BC of the base station is established, determining whether reciprocal BC is established based on the information on whether the BC of the terminal is established and whether the BC of the base station is established, and determining whether to perform an uplink beam management operation based on whether the reciprocal BC is established, and a base station for performing the same.

### CROSS-REFERENCE TO RELATED APPLICATION(S)

This application is based on and claims priority under 35 U.S.C. § 119(a) of a Korean patent application number 10-2017-0016367, filed on Feb. 6, 2017, in the Korean Intellectual Property Office, the disclosure of which is incorporated by reference herein in its entirety.

### TECHNICAL FIELD

The disclosure relates to a method for beam searching and management in a wireless communication system. More particularly, the disclosure relates to a method for beam searching and management considering beam correspondence (BC).

### BACKGROUND

To meet the demand for wireless data traffic having increased since deployment of fourth generation (4G) communication systems, efforts have been made to develop an improved fifth generation (5G) or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid frequency shift keying (FSK) and quadrature (QAM) modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for beam searching and management in a wireless communication system.

Another aspect of the disclosure is directed to the provision of a method for beam searching and management considering beam correspondence (BC).

In accordance with an aspect of the disclosure, a method for beam management of a base station is provided. The method includes receiving information on whether BC of a terminal is established, identifying information on whether BC of a base station is established, determining whether reciprocal BC is established based on the information on whether the BC of the terminal is established and whether the BC of the base station is established, and determining whether to perform an uplink beam management operation based on whether the reciprocal BC is established.

In accordance with an aspect of the disclosure, a base station is provided. The base station includes a transceiver configured to transmit and receive a signal, and at least one processor configured to perform a control to receive information on whether beam correspondence (BC) of a terminal is established, identify information on whether BC of a base station is established, determine whether reciprocal BC is established based on the information on whether the BC of the terminal is established and the information on whether the BC of the base station is established, and determine whether to perform the uplink beam management operation based on whether the reciprocal BC is established.

In accordance with an aspect of the disclosure, a method for beam management of a terminal is provided. The method includes acquiring information on whether BC of the terminal is established, transmitting information on whether the BC of the terminal is established to a base station, receiving information on whether reciprocal BC is established from the base station, and determining whether to perform an uplink beam management operation based on the information on whether the reciprocal BC is established.

In accordance with an aspect of the disclosure, a terminal is provided. The terminal includes a transceiver configured to transmit and receive a signal, and at least one processor configured to perform a control to acquire information on whether BC of the terminal is established, transmit the information on whether the BC of the terminal is established to a base station, receive information on whether reciprocal BC is established from the base station, and determine whether to perform an uplink beam management operation based on the information on whether the reciprocal BC is established.

According to the embodiment of the disclosure, it is possible to provide the method for beam searching and management in the wireless communication system. Further, according to the embodiment of the disclosure, it is possible to provide the method for beam searching and management considering the BC.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a wireless communication system according to an embodiment of the disclosure;

FIG. 2 is a diagram for explaining a beamforming operation in a wireless communication system according to an embodiment of the disclosure;

FIG. 3 is a diagram illustrating a method for determining whether the BC is established according to an embodiment of the disclosure;

FIG. 4 is a diagram for explaining a process of transmitting information indicating whether the beam correspondence (BC) is established from a terminal to a base station according to an embodiment of the disclosure;

FIG. 5 is a diagram illustrating a method for determining whether the BC is established based on beam measurement according to an embodiment of the disclosure;

FIG. 6 is a diagram illustrating a downlink (DL) beam management procedure according to an embodiment of the disclosure;

FIG. 7 is a diagram illustrating an uplink (UL) beam management procedure according to an embodiment of the disclosure;

FIG. 8 is a diagram illustrating the number of cases indicating whether the BC is established according to an embodiment of the disclosure;

FIG. 9 is a diagram illustrating an uplink beam searching method according to the embodiment of the disclosure;

FIG. 10 is a diagram illustrating an operation of a base station according to an embodiment of the disclosure;

FIG. 11 is a diagram illustrating an operation of a terminal according to an embodiment of the disclosure;

FIG. 12 is a diagram illustrating a base station according to an embodiment of the disclosure; and

FIG. 13 is a diagram illustrating a terminal according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments of the disclosure in the present specification, a description of technical contents which are well known to the art to which the disclosure belongs and are not directly connected with the disclosure will be omitted. This is to more clearly transfer a gist of the disclosure by omitting an unnecessary description.

For the same reason, some components are exaggerated, omitted, or schematically illustrated in the accompanying drawings. Further, the size of each component does not exactly reflect its real size. In each drawing, the same or corresponding components are denoted by the same reference numerals.

Various advantages and features of the disclosure and methods accomplishing the same will become apparent from the following detailed description of embodiments with reference to the accompanying drawings. However, the disclosure is not limited to the embodiments disclosed herein but will be implemented in various forms. The embodiments have made disclosure of the disclosure complete and are provided so that those skilled in the art may easily understand the scope of the disclosure. Therefore, the disclosure will be defined by the scope of the appended claims. Like reference numerals throughout the description denote like elements.

In this case, it may be understood that each block of processing flow charts and combinations of the flow charts may be performed by computer program instructions. Since these computer program instructions may be mounted in a processor of a general computer, a special computer, or other programmable data processing apparatuses, these computer program instructions executed through the process of the computer or the other programmable data processing apparatuses create means performing functions described in a block(s) of the flow chart. Since these computer program instructions may also be stored in a computer usable or computer readable memory of a computer or other programmable data processing apparatuses in order to implement the functions in a specific scheme, the computer program instructions stored in the computer usable or computer readable memory may also produce manufacturing articles including instruction means performing the functions described in block(s) of the flow charts. Since the computer program instructions may also be mounted on the computer or the other programmable data processing apparatuses, the instructions performing a series of operations on the computer or the other programmable data processing apparatuses to create processes executed by the computer, thereby executing the computer or the other programmable data processing apparatuses may also provide steps for performing the functions described in a block (s) of the flow chart.

In addition, each block may indicate some of modules, segments, or codes including one or more executable instructions for executing a specific logical function (specific logical functions). Further, it is to be noted that functions mentioned in the blocks occur regardless of a sequence in some alternative embodiments. For example, two blocks that are continuously illustrated may be simultaneously performed in fact or be performed in a reverse sequence depending on corresponding functions.

Here, the term ‘˜unit’ used in the embodiment means software or hardware components such as field programmable gate array (FPGA) and application specific integrated circuit (ASIC) and the ‘˜unit’ performs any roles. However, the meaning of the ‘˜unit’ is not limited to software or hardware. The ‘˜unit’ may be configured to be in a storage medium that may be addressed and may also be configured to reproduce one or more processor. Accordingly, for example, the ‘˜unit’ includes components such as software components, object oriented software components, class components, and task components and processors, functions, attributes, procedures, subroutines, segments of program code, drivers, firmware, microcode, circuit, data, database, data structures, tables, arrays, and variables. The functions provided in the components and the ‘˜units’ may be combined with a smaller number of components and the ‘˜units’ or may be further separated into additional components and ‘˜units’. In addition, the components and the ‘˜units’ may also be implemented to reproduce one or more central processing units (CPUs) within a device or a security multimedia card.

To meet a demand for radio data traffic that is on an increasing trend since commercialization of a fourth generation (4G) communication system, efforts to develop an improved fifth generation (5G) communication system have been conducted. To achieve a high data rate, the 5G communication system is considered to be implemented in a very high frequency band (mmWave) band. In order to alleviate a path loss of a radio wave and increase a transmission distance of the radio wave in the very high frequency band, beamforming is essential in the 5G communication system and analog beamforming may be considered in the mmWave band to use multiple antenna arrays. In addition, hybrid beamforming, in which analog beamforming and digital beamforming are used together, is also considered.

In a system using the analog beamforming, each base station (evolved node B (eNB), new radio (NR) base station (gNB), transmission reception point (TRP), etc.) and a terminal should determine a beam to be used for transmission/reception. Here, the beam to be used at the time of transmission may be also used at the same time, or other beams may be used. In this regard, the establishment of the beam correspondence (BC) may be defined as follows. The BC may also be referred to as beam reciprocity. Beam management can be termed beam operation or beam control. In the embodiment of the disclosure, the establishment of the BC can be expressed as the validity of the BC, a BC state, or a BC valid state.

DL Tx & Rx beam searched by downlink (DL) beam management (or DL beam search) can be applied as UL Rx & Tx beam (downlink transmission beam of a base station searched through DL beam management can be applied as an uplink reception beam and a downlink reception beam of a terminal searched through the DL beam management can be applied as an uplink transmission beam).

UL Tx & Rx beam searched by uplink (UL) beam management (or UL beam search) can be applied as DL Rx & Tx beam (uplink transmission beam of a terminal searched through UL beam management can be applied as a downlink reception beam and an uplink reception beam of a base station searched through the DL beam management can be applied as a downlink transmission beam).

When the BC is established, the base station may use the transmission beam of the base station for the terminal as the reception beam of the base station for the terminal, and conversely, may use the reception beam of the base station as the transmission beam of the base station. The terminal may use the transmission beam of the terminal for the base station as the transmission beam for the base station, and conversely, use the reception beam of the terminal as the transmission beam of the terminal. That is, when BC is established, each node can use the same reception beam as the transmission beam, or use the same transmission beam as the reception beam. If the BC is established, the terminal and/or the base station may perform only one of the DL beam management and the UL beam management and apply it to both of the DL and UL transmission/reception beams. For example, if the BC is established, only the DL beam management is performed to be able to identify the beam to be used for transmission/reception at each node without performing the UL beam management as the DL beam management result. If BC is established, the downlink transmission beam of the base station and the downlink reception beam of the terminal may be identified based on the DL beam management and if the BC is established, the uplink reception beam of the base station and the uplink transmission beam of the terminal may be identified.

In the following embodiments of the disclosure, if the BC is established, the DL beam management result will be described as being applied to the UL transmission/reception beam. In contrast, the embodiment of the disclosure is applicable to the case in which the UL beam management result is applied to the DL transmission/reception beam.

Factors affecting the establishment of the BC are as follows. First, if a transmitting antenna (or antenna array or antenna panel) and a receiving antenna are separated at a specific node (base station or terminal), the establishment of the BC may be affected. That is, the hardware configuration of the antenna may affect the establishment of the BC. In addition, a duplex mode may also affect the establishment of the BC. In case of time division duplex (TDD), the BC is more likely to be established than frequency division duplex (FDD). In addition, if beam patterns or beam widths of the transmission/reception analog beams are different, the BC may not be established. The influence of the channel may also affect the BC. An influence of the interference on the reception at a specific node may affect the transmission beam search and the reception beam search differently, and therefore the establishment of the BC can be changed.

In an analog beamforming or hybrid beamforming system, it may be assumed that the BC is always established or the BC is not always established. If it is assumed that the BC is always established, only the DL beam management may be performed and the UL beam management may be omitted. If it is assumed that the BC is not always established, the DL beam management and the UL beam management may be performed independently.

The BC is assumed to be established and operated. However, if the BC is not actually established depending on the factors affecting the BC, the relationship between the transmission beam and the reception beam is not appropriate, such that the communication efficiency may be poor or difficult. On the other hand, the BC is assumed to be established and the UL beam management is omitted. Actually, if the BC is established, it is unnecessary to perform the UL beam management, and it may be an operation of lowering efficiency of each node. According to an embodiment of the disclosure, a method for determining whether the BC is established so that each node may perform appropriate operation at each node according to whether the BC is established and performing appropriate beam management accordingly is provided.

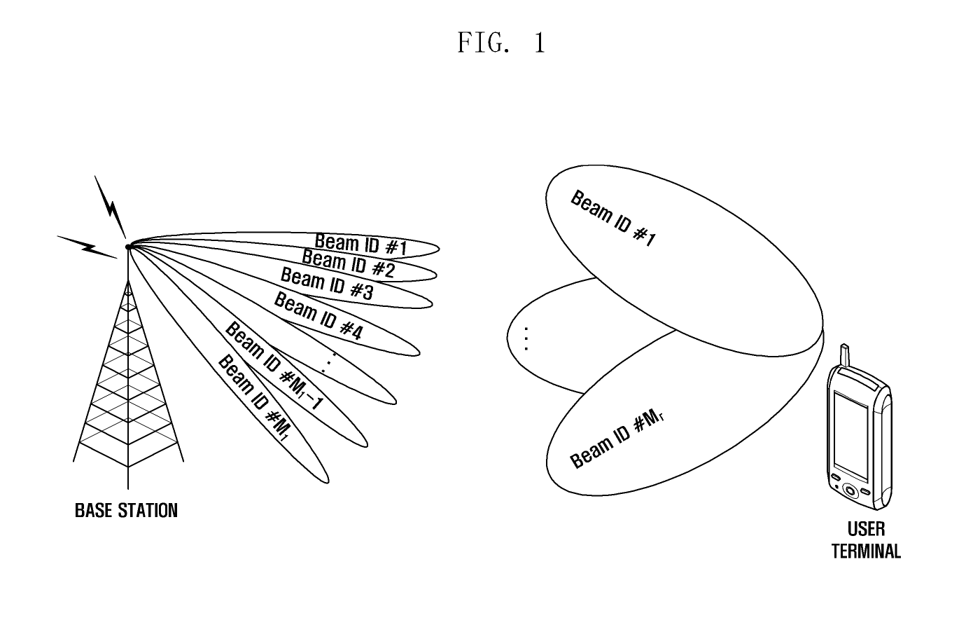

FIG. 1 is a diagram illustrating a wireless communication system according to an embodiment of the disclosure.

Referring to FIG. 1, a system according to an embodiment of the disclosure includes a base station and a terminal that form analog beams having various directivities. Here, the analog beam used by the base station and the terminal may be formed by a plurality of small antenna arrays, and wireless transmission/reception may be performed in one direction using one antenna array group at a time. At this time, when at least one antenna array group can be simultaneously operated, the wireless transmission/reception may be performed in more than one direction at a time.

The embodiment of the disclosure has basically considered the environment that the base station (or transmitting/receiving ends) or the terminal perform transmission/reception using a pair of beams at a time by using at least one beam within a multi-antenna using beamforming system which differently allocates and uses resources, such as a frequency channel, time, a beam, and a code, to different beams and uses the resources. In addition to this, an applicable beam information exchange method even when the base station or the terminal does not use a plurality of beams, but for example, the base station uses at least one beam or the terminal uses one beam or the base station uses one beam or the terminal uses at least one beam is proposed.

In the wireless communication system using the multi-beam, the terminal may exchange beam information which is being used in the same base station (or a transmitting/receiving end) through three operations of 1) measurement of beam information, 2) provision of beam information, and 3) change of beam which is being used, and change a beam to search for a suitable beam at each time and use the corresponding beam. In the multi-antenna beamforming system which differently allocates resources, such as the frequency channel, the time, the beam, and the code, to different beams and uses the resources, the base station and the terminal should be able to detect and track the channel state of the transmission/reception beam in real time, and maintain and change the beam which is being used. To this end, it is necessary to perform operations such as beam measurement, beam measurement result feedback, and beam change.

A. Beam Measurement

The beam measurement is performed to measure channels of beam pairs which may result in combinations of various beams between the terminal and neighboring base stations.

The beam measurement may be performed periodically or aperiodically, and performed by the terminal or the base station.

The embodiment of the disclosure is not limited by any beam measuring method, and may be assumed that the terminal or the base station may measure the channel state of the beam pairs.

The embodiment of the disclosure may be assumed to be the environment that the terminal continuously (background) performs an operation of measuring beam information regardless of the method, and as a result thereof, performs an operation of updating and measuring a measured value according to each beam information measurement.

B. Beam Feedback or Beam Reporting

The beam feedback is an operation of informing the base station of the beam information measured by the terminal.

Since the base station (or terminal) which is the transmitting end may not know the downlink (or uplink) beam information, the feedback of the terminal (or base station) is essential.

The beam information feedback may be performed periodically or aperiodically, and performed by the terminal or the base station.

The embodiment of the disclosure mainly describes an operation of transmitting the beam information measured by the terminal to the base station. However, the scope of the disclosure is not limited to the beam feedback or the reporting of the terminal, but may be applied corresponding to the operation of transmitting the beam information measured by the base station to the terminal. Therefore, the procedures of the beam feedback and the beam change of the terminal below may be applied equally/similarly by the operation of the base station.

In the embodiment of the disclosure, the beam feedback and the beam feedback information may be beam state information (BSI) and beam refinement information (BRI).

C. Beam Change

The base station or the terminal may determine a beam pair to be used in future based on the received beam feedback information.

The base station or the terminal may perform various operations to use the determined beam pair.

In the following embodiments, a best beam (or best beams) may refer to one beam pair (or beam pairs) including beams of a beam measuring subject and a beam using subject or two beams within the beam pair (or beam pairs), respectively, when one beam of the beam measuring subject and one beam of the beam using subject, which are assumed to have the best performance among the analog beams usable by the beam measuring subject and the beam using subject, are determined. In the embodiment of the disclosure, the best beam may generally be the best performance beam of the beam using subject which is used to perform communication between the beam using subject (base station) and the beam measuring subject (terminal) within a best beam pair measured according to a reference signal that the beam using subject (base station) transmits. However, the disclosure is not limited thereto and may mean various examples of the best beam described in the embodiment of the disclosure.

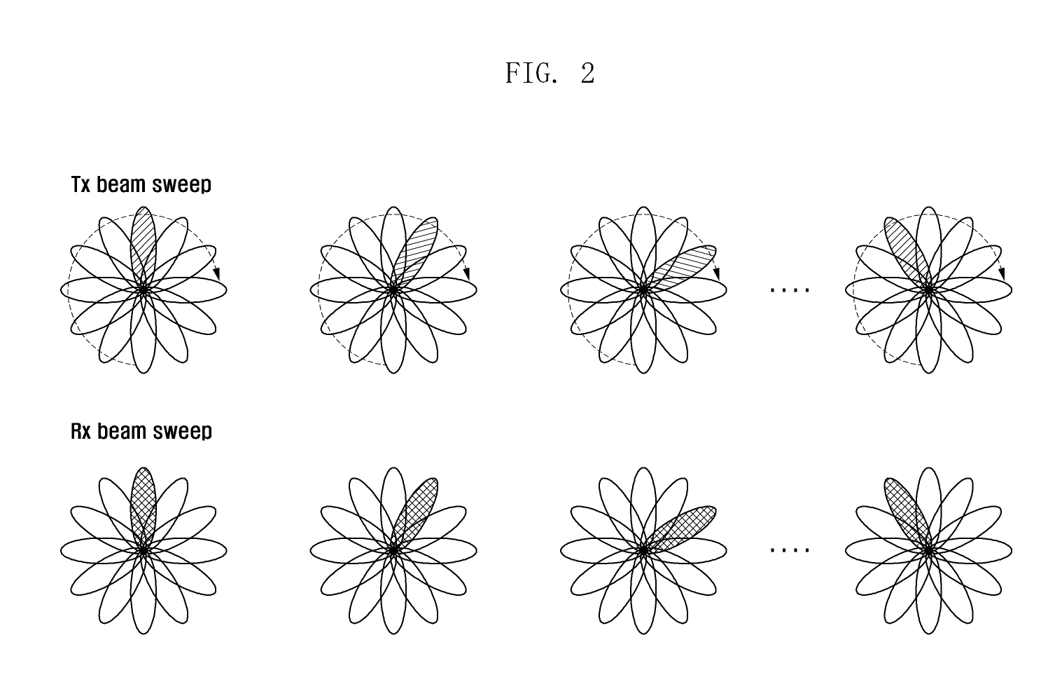

FIG. 2 is a diagram for describing the beamforming operation in the wireless communication system according to the embodiment of the disclosure.

Referring to FIG. 2, the wireless communication system includes a plurality of nodes (e.g., a base station and a plurality of terminals), in which one node may search for a best beam for wireless communication with a counterpart node and transmit the best beam to transmit/receive data to/from the corresponding beam. In the embodiment, at least one of analog beamforming and digital beamforming may be applied for the beamforming. The analog beamforming may be performed by adjusting the shape and direction of the beam using a difference in amplitude and phase of a carrier signal in an RF band. The digital beamforming processes a signal by adding each weight vector to a digitized signal, and passes RF signals from each antenna to a digital band through a separate RF transmitter/receiver. The digital beamforming may implement the beamforming by digital signal processing, and generate sophisticated beam according to communication requirements according to signal processing ability.

Each node may form a Tx beam and an Rx beam. In order for each node to search for a beam suitable for communication, as illustrated in FIG. 2, a full beam sweep may be performed as many as the number of transmission beams and the number of reception beams. The process of searching for the best beam for the counterpart node may be referred to as beam searching. To this end, the related reference signal may be transmitted and received.

In the embodiment, the reference signal may include a cell-specific reference signal and a UE-specific reference signal, and each signal may be transmitted periodically or aperiodically. An example of the reference signal may include a beam reference signal (BRS) and a beam refinement reference signal (BRRS).

In the embodiment, the BRS may be periodically transmitted and may be a cell-specific reference signal. Also, in the embodiment, the BRRS is a UE-specific reference signal and may be transmitted aperiodically. In another embodiment, the BRRS may be the UE-specific reference signal, and the allocation of the BRRS may be statically or semi-statically allocated. At this time, the BRRS may be periodically or aperiodically transmitted within the allocated period.

In the embodiment, the terminal may measure at least one of the BRS and the BRRS transmitted from the base station, and report information on the specific beams to the base station. The information reported to the base station may include at least one of the following information.

BRS based beam state information (BSI): beam index (BI) of the corresponding beam and quality information of the corresponding beam (e.g., beam reference signal received power (BRSRP), beam reference signal quality (BRSRQ), beam received signal strength indicator (BRSSI)).

BRRS based beam refinement information (BRI): BRRS resource index (BRRS-RI) and the quality information of the corresponding beam (e.g., BRRS received power (BRRS-RP)) for identifying the BRRS beam.

In the embodiment of the disclosure, there may be three methods for determining whether the BC is established. Case 1 is to perform pre-determination at each node, and case 2 is to determine whether the BC is established based on the beam measurement. Case 3 is a method for using the case 1 at the initial stage of a terminal access and the case 2 after the initial access, and may be implemented by a combination of the case 1 and the case 2.

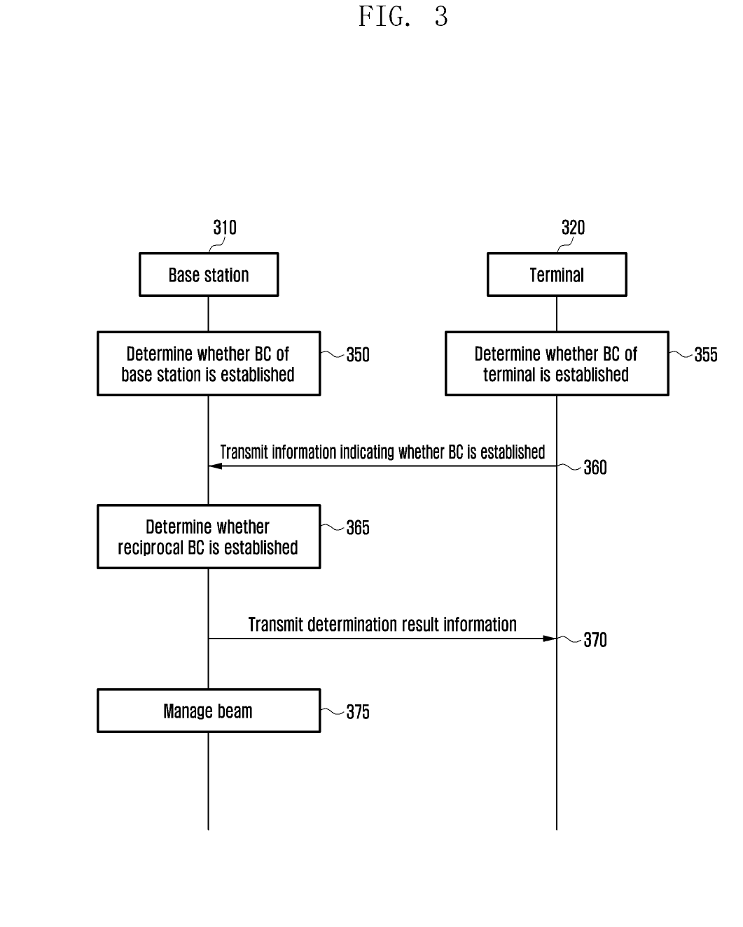

First, the case 1 will be described. FIG. 3 is a diagram illustrating a method for determining whether the BC is established according to an embodiment of the disclosure. The case 1 is a method for providing information on whether the BC is established to the base station at the time of the initial access of the terminal and using the information.

Referring to FIG. 3, the wireless communication system may include a base station 310 and a terminal 320. The base station 310 may perform the following operations performed with the terminal 320, with respect to a plurality of terminals.

Each node may determine whether the BC is established beforehand. In operation 350, the base station 310 may determine whether the BC is established for its own transmission beam and reception beam. In operation 355, the terminal 320 may determine whether the BC is established for its own transmission beam and reception beam. For example, the base station 310 may determine whether the BC is established based on its own antenna hardware characteristics, and the terminal 320 may determine whether the BC is established based on its own antenna hardware characteristics. In the operations 350 and 355, when each node stores the information on whether the BC is established, the corresponding information is used. In this case, a separate determination procedure is unnecessary and the stored information may be used. Meanwhile, the base station 310 and the terminal 320 may determine whether the BC is established by simultaneously considering the hardware characteristics and the radio channel environment. That is, the establishment of the BC based on the hardware characteristics is satisfied when the radio channel environment satisfies specific conditions, and the BC may not be established if the radio channel environment does not satisfy the specific channel conditions. For example, the specific conditions may be the channel environment, the connection mode (FDD, TDD), whether the uplink and downlink are connected to the same TRP and the like.

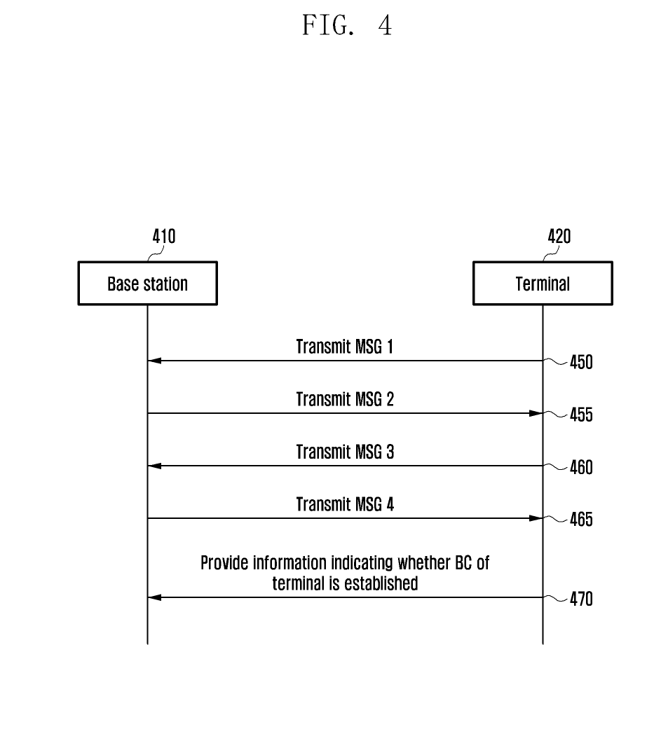

In operation 360, the terminal 320 transmits information indicating whether the BC of the terminal is established to the base station 310. In the embodiment of the disclosure, the information indicating whether the BC is established may be used as the validity of the BC or the information indicating the validity of the BC, and the information may be used as the BC validity indication. The terminal 320 may provide the information to the base station 310 upon the initial access of the terminal. For example, the terminal 320 may transmit UE capability information including information indicating whether the BC of the terminal is established. The information indicating whether the BC of the terminal is established may be transmitted from the terminal 320 to the base station 310 through a radio resource control (RRC) message. The information indicating whether the BC of the terminal is established may also be provided in an initial random access process of the terminal 320. This will be described in more detail in FIG. 4.

In operation 365, the base station 310 may determine whether the BC is established based on the information indicating whether the BC is established which is received from the terminal. The determination on whether the BC is established is the determination on whether the BC is established for both the terminal 320 and the base station 310. For example, if the BC is established in the terminal 320 and the BC is also established in the base station 310, the reciprocal BC may be established. If the BC is not established for at least one of the terminal 320 and the base station 310, the reciprocal BC is not established. The base station 310 may determine whether the reciprocal BC is established based on the operations 350 and 360.

In operation 370, the base station 310 may provide the terminal 320 with the determination result on which the reciprocal BC establishment. The determination result may be the information indicating whether the reciprocal BC is established, or the information indicating the operation of the terminal 320 depending on whether the reciprocal BC is established. The operation 370 may be omitted.

In operation 375, the base station 310 may operate the beam based on the determination result whether the reciprocal BC is established. The base station 310 may trigger DL beam management or UL beam management based on whether the reciprocal BC is established. It may be determined whether to perform the UL beam management is according to whether the reciprocal BC is established, and when the UL beam management is performed, it may be determined whether to sweep the beam or use a fixed beam. The detailed beam operation procedures will be described in detail later.

FIG. 4 is a diagram for explaining a process of transmitting information indicating whether the BC is established from a terminal to a base station according to an embodiment of the disclosure.

Referring to FIG. 4, the wireless communication system may include a base station 410 and a terminal 420. FIG. 4 illustrates a process in which the terminal 420 initially accesses using a random access.

In operation 450, the terminal 420 transmits message 1 (MSG1) to the base station 410. The message 1 corresponds to a random-access preamble transmission of the terminal through a random-access channel (RACH).

In operation 455, the base station 410 transmits message 2 (MSG2) to the terminal 420. The message 2 corresponds to the random access response transmission of the base station 410 through the physical downlink control channel (PDCCH) channel.

In operation 460, the terminal 420 transmits message 3 (MSG3) to the base station 410. The message 3 may include a buffer status report (BSR) of the terminal through the PUSCH channel or an uplink information transmission or a beam feedback information transmission. In addition, the message 3 may include information indicating whether the BC of the terminal 420 is established. In the embodiment of the disclosure, it is possible to provide information indicating whether the BC of the terminal is established to the base station 410 by including the information in the MSG 3 upon the initial access of the terminal 420.

In operation 465, the base station 410 transmits message 4 (MSG4) to the terminal 420. The message 4 corresponds to a contention resolution transmission of the base station through the PDCCH channel.

The terminal 420 may additionally perform operation 470. In the operation 470, the terminal 420 may transmit information indicating whether the BC of the terminal is established to the base station 410. For example, if the terminal 420 does not provide the information indicating whether the BC of the terminal is established through the MSG 3, the terminal 420 may provide information indicating whether the BC is established to the base station 410 in the operation 470 after the random access procedure ends. The terminal 420 may transmit UE capability information including information indicating whether the BC of the terminal is established.

By the above-mentioned method, the terminal 420 may provide the base station 410 with the information indicating whether the BC is established during the random access or after the random access.

The base station 410 may perform operations below the operation 365 of FIG. 3 after receiving the information indicating whether the BC of the terminal is established from the terminal 420.

The above embodiment may be applied to an operation of performing RACH procedures, such as performing an initial cell access by a terminal, performing a cell access after a radio link failure (RLF) occurs, performing an access in a target cell upon handover, performing beam recovery at the time of beam misalignment, and performing a cell access due to reception of a paging or generation of uplink data in an idle mode.

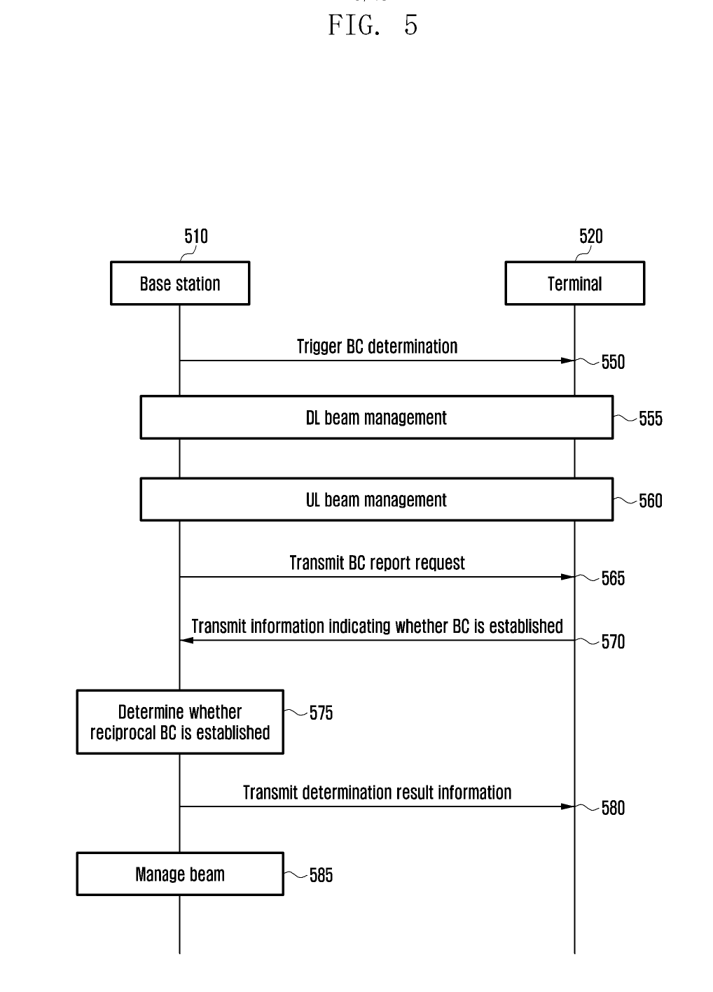

Next, the case 2 will be described. The case 2 determines whether the BC is established based on the beam measurement. FIG. 5 is a diagram illustrating a method for determining whether the BC is established based on beam measurement according to an embodiment of the disclosure.

Referring to FIG. 5, the wireless communication system may include a base station 510 and a terminal 520.

In operation 550, the base station 510 may transmit to the terminal 520 information that triggers the determination of the BC. For example, the information may be a BC determination trigger. Triggering the determination of the BC means determining whether the BC is established based on the beam measurement of the terminal and/or the base station. The information triggering the determination of the BC may be made using downlink control information (DCI) or a medium access control (MAC) control element (CE). Therefore, the base station 410 may transmit a DCI indication or a MAC CE indication to the terminal 420 to trigger the determination of the BC, and the DCI indication or the MAC CE indication may include information that triggers the determination of the BC.

The base station 510 may perform the operation 550 if it determines that the determination of the BC is necessary. On the other hand, when the base station 510 receives the determination request of the BC from the terminal 520, the base station 510 may perform the operation 550. The terminal 520 may transmit to the base station 510 the information requesting to trigger the determination of the BC when the determination of the BC is required. The information may be a BC determination request. The terminal 520 may transmit to the base station 510 the information requesting to trigger the determination of the BC by using uplink control information (UCI). The UCI may be transmitted through a physical uplink control channel (PUCCH) or a physical uplink shared channel (PUSCH).

In operation 555, the terminal 520 and the base station 510 may perform a downlink beam management operation. Through the downlink beam management operation, the base station 510 may identify information on its own transmission beam, and the terminal may identify information on its own reception beam. The base station 510 may transmit a reference signal to the terminal 520. The reference signal may be a reference signal for measuring the beam. The terminal may identify the transmission beam of the base station 510 by measuring the reference signal. Also, the terminal 520 may identify the reception beam of the terminal 520 by measuring the reference signal. For example, the terminal 520 may identify a best transmission beam of the base station 510, and the terminal 520 may identify its own best reception beam. The terminal 520 may identify the reception beam of the terminal corresponding to the transmission beam of the base station 510. The terminal 520 may provide information on the transmission beam of the identified base station 510 to the base station. For example, the terminal 520 may transmit the information on the index of the transmission beam of the base station 510 and/or the information (e.g., RSRP) on the quality of the corresponding beam to the base station 510.

On the other hand, the operation 555 can be omitted. For example, when the base station 510 and the terminal 520 periodically perform the DL beam management, the operation 555 may be omitted, and the information on the transmission beam of the base station 510 and the information on the reception beam of the terminal 520, which have been identified by the periodic DL beam management, may be used. When the information on the beam is identified in advance by the aperiodic DL beam management, the operation 555 may be omitted if it is determined that the corresponding information is valid.

In operation 560, the terminal 520 and the base station 510 may perform an uplink beam management operation. Through the uplink beam management operation, the terminal 520 may identify information on its own transmission beam, and the base station 510 may identify information on its own reception beam. The terminal 520 may transmit the reference signal to the base station 510. The reference signal may be a reference signal for measuring the beam. The base station 510 may measure the reference signal to identify the transmission beam of the terminal 520 and identify the reception beam of the terminal 520. For example, the base station 510 may identify the best transmission beam of the terminal 520, and may identify its own best reception beam. The base station 510 may identify its own reception beam corresponding to the transmission beam of the terminal 520. The base station 510 may provide the information on the transmission beam of the identified terminal to the terminal 520. For example, the base station 510 may transmit the information on the index of the transmission beam of the terminal 520 and/or the information (e.g., RSRP) on the quality of the corresponding beam to the terminal 520.

In operation 565, the base station 510 may instruct the terminal 520 to report the result on whether the BC is established. The base station 510 may transmit to the terminal 520 the information indicating the report of the result on which the BC is established. The base station 510 may transmit to the terminal 520 the information indicating the report of the result on which the BC is established by using the DCI or the MAC CE.

The terminal 520 may identify the information on its own transmission beam and reception beam from the operations 555 and 560, and identify whether the BC is established by comparing the information on the identified transmission beam and reception beam. If the operation 555 is omitted, the information on the reception beam of the terminal 520 that has already been identified may be compared with the information on the transmission beam of the terminal identified in the operation 560 to identify whether the BC is established. For example, it can be determined that BC is established if the indexes of the reception beam identified through the operation 555 and the transmission beam identified through the operation 560 are the same.

In operation 570, the terminal 520 may transmit the information indicating whether the BC is established to the base station 510. The information indicating whether the BC is established may be 1-bit information. The terminal 520 may transmit the information indicating whether the BC is established through the UCI. The terminal 520 may transmit the UCI through the PUCCH or the PUSCH.

In operation 575, the base station 510 may determine whether the BC is established for both of the base station 510 and the terminal 520. That is, the base station 510 may determine whether the reciprocal BC is established. The base station 510 may determine whether the reciprocal BC is established based on the determination on whether the BC of the base station 510 is established or not and the information indicating whether the BC of the terminal 520 received from the terminal 520 is established. The determination on whether the BC is established is the determination on whether the BC is established for both the terminal 520 and the base station 510. For example, if the BC is established in the terminal 520 and the BC is also established in the base station 510, the reciprocal BC may be established. If the BC is not established for at least one of the terminal 520 and the base station 510, the reciprocal BC is not established.

The terminal 510 may identify the information on its own transmission beam and reception beam from the operations 555 and 560 prior to the operation 575, and identify whether the BC of the base station 510 is established by comparing the information on the identified transmission beam and reception beam. If the operation 555 is omitted, the information on the transmission beam of the terminal 520 that has already been identified may be compared with the information on the reception beam of the base station 510 identified in the operation 560 to identify whether the BC is established. For example, it can be determined that BC is established if the indexes of the transmission beam identified through the operation 555 and the reception beam identified through the operation 560 are the same.

In operation 580, the base station 510 may provide the terminal 520 with the determination result on which the reciprocal BC establishment. The determination result may be the information indicating whether the reciprocal BC is established, or the information indicating the operation of the terminal 520 depending on whether the reciprocal BC is established. The operation 580 may be omitted.

In operation 585, the base station 510 may operate the beam based on the determination result whether the reciprocal BC is established. The base station 510 may trigger DL beam management or UL beam management based on whether the reciprocal BC is established. It may be determined whether to perform the UL beam management is according to whether the reciprocal BC is established, and when the UL beam management is performed, it may be determined whether to sweep the beam or use a fixed beam. The detailed beam operation procedures will be described in detail later.

Meanwhile, each node (each of the base station 510 and the terminal 520) may compare at least one transmission beam with the reception beam when determining whether the BC is established. For example, N beam pairs may be compared (N transmission beams and N transmission beams may be compared). In the case in which each node uses information on N beams, when the beam information is reported as a measurement result, the counterpart node should provide information on N beams. For example, in the DL beam management process, the terminal 520 should transmit the measurement results on the transmission beams of N base stations 520 to the base station 510 and store the measurement results on the reception beams of N terminals 520. In addition, in the DL beam management process, the terminal 520 should transmit the measurement results on the transmission beams of N terminals 520 to the terminal 520 and store the measurement results on the reception beams of N base stations 510. Thereafter, each node may determine whether the BC is established by comparing N transmission beams and N reception beams of each node. N may be determined at the base station 510, and information about N may be provided to the terminal 520 in advance. The information on the N beams may be variously combined. For example, information on upper N beams having good quality may be provided, and information on upper N−1 beams with good quality and information on one beam with the worst quality may be provided. As such, the combination of information on the N beams may be diverse.

When the information on the N beams is obtained, each node may be determined whether the BC is established in the following manner.

1) Compare all N transmission beam/reception beam pairs.

It is possible to compare N transmission beams and N transmission beams at each node and determine that the BC is established when the transmission beams and the reception beams correspond to all of the N beam pairs.

2) Comparison of M (M<N) transmission beam/reception beam pairs to be used in the communication between the terminal 520 and the base station 510.

Each node may compare N transmission beams with M beam pairs or M or more beam pairs among N transmission beam pairs to determine that the BC is established when the transmission beam and the reception beam correspond to M or more beam pairs.

A method for determining the BC of the transmission beam and the reception beam according to the embodiment of the disclosure is as follows.

1) Determine the BC by comparing whether the directions of the transmission beam and the reception beam are the same.

Each node may determine that the BC is established if the directions of the transmission beams and the reception beams of each node are the same. If the beam indexes are the same, it may be determined that the beam directions are the same. Therefore, if the indexes of the transmission beam and the reception beam are the same, it may be determined that the BC is established. In addition, it is possible to determine whether the BC is established by comparing the beam directions (AoA/AoD).

2) Determine the BC by considering the beam direction and the beam quality.

Each node may compare the beam qualities by being added to the method 1) to determine whether the BC is established. The beam quality may include reference signal received power (RSRP), reference signal received quality (RSRQ), a signal-to-interference-plus-noise ratio (SINR), a signal-to-noise ratio (SNR) and the like. Hereinafter, the method for using RSPR will be described. The method for using RSRP can be similarly applied to the RSRQ, the SINR, the SNR and the like. In the following description, it is assumed that the condition of 1) is satisfied and the method considering the quality of the beam will be described.

Generally, since the transmit power of the uplink and the transmit power of the downlink are different, when the RSRP acquired through the downlink transmission and the RSRP acquired through the uplink transmission are compared, the RSRPs each may be compared with each other by being normalized by the transmit power. By the normalization, the RSRP value per unit transmit power may be identified. The following Equation 1 represents the DL unit RSRP, which represents the RSRP value per unit transmit power in the downlink. The following Equation 2 represents the UL unit RSRP, which represents the RSRP value per unit transmit power in the uplink.

DL unit RSRP: RSRP measurement value of terminal/RS transmit power of base station Equation 1

UL unit RSRP: RSRP measurement value of RSRP base station/RS transmit power of terminal Equation 2

Each node may compare the RSRP of the normalized transmission beam with the RSRP of the normalized reception beam to determine whether the BC is established. The above Equation 1 may be performed in the terminal 520, and the above Equation 2 may be performed in the base station 510. However, the embodiment is not limited thereto, and if the terminal 520 provides the RSRP measurement value to the base station, the Equation 1 may be performed in the base station 510, and if the base station 510 provides the RSRP measurement value, the above Equation 2 may be performed in the terminal 520. In addition, the above Equations 1 and 2 each may be performed at each node when the information on the RSRP and the transmit power are provided to each other.

The base station 510 and/or the terminal 520 may compare the DL unit RSRP with the UL unit RSRP to determine that the BC is established when the difference between the two values is equal to or less than a preset threshold value. In addition, the DL unit RSRP and the UL unit RSRP may be compared with each other to determine that the BC is established if the ratio of the two values exceeds a predetermined threshold ratio. In addition to this, the method for comparing DL unit RSRP with UL unit RSRP may be diverse.

In order to normalize the RSRP, the transmitting side that transmits the reference signal should provide the information on the transmit power to the receiving side. In the downlink, since the base station 510 transmits the reference signal, the base station 510 needs to provide the information on the transmit power of the base station 510 to the terminal 520. The base station 510 may provide the information on the transmit power of the base station 510 using at least one of the RRC message, the DCI, and the MAC CE. In the uplink, since the terminal 520 transmits the reference signal, the terminal 520 needs to provide the information on the transmit power of the terminal 520 to the base station 510. The terminal 520 may provide information on its own transmit power using the UCI. The information on the transmit power may be provided to each node prior to determining the BC.

By the above-described method, it is possible to confirm whether the BC is established at each node based on the direction of the beam (based on the beam index) and/or the quality of the beam.

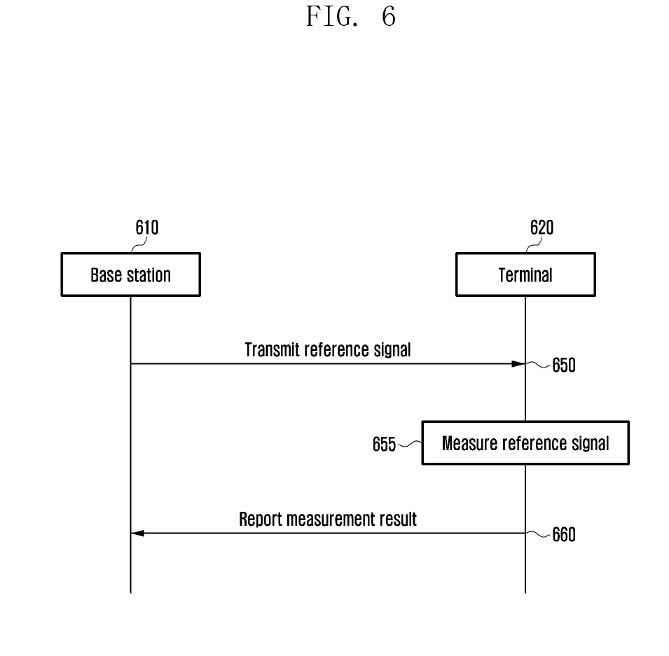

FIG. 6 is a diagram illustrating a DL beam management procedure according to an embodiment of the disclosure. FIG. 6 corresponds to the operation 555 of FIG. 5.

Referring to FIG. 6, the wireless communication system may include a base station 610 and a terminal 620.

In operation 650, the base station 610 may transmit the reference signal to the terminal 620. As illustrated in FIG. 2, the base station 610 may perform the beam sweep based on the number of transmission beams and the number of reception beams. To this end, the reference signal may be transmitted from each transmission beam. The reference signal may be the cell specific reference signal, or may be the UE-specific reference signal. The reference signal may be the BRS or the BRRS.

In operation 655, the terminal 620 may measure the reference signal transmitted by the base station 610. The terminal 620 may sweep its own reception beam and measure the reference signal with respect to the reference signal that the base station 610 transmits by performing the beam sweep. The operation of the beam sweep is described with reference to FIG. 2. Through the reference signal measurement, the terminal 620 may identify the transmission beam of the base station 610. Also, the terminal 620 may identify the reception beam of the terminal 620 corresponding to the transmission beam of the base station 610 by measuring the reference signal. For example, the terminal 620 may identify a best transmission beam of the base station 610, and the terminal 620 may identify its own best reception beam. The terminal 620 may identify the reception beam of the terminal corresponding to the transmission beam of the base station 610.

In operation 660, the terminal 620 may transmit the measurement result to the base station 610. The measurement result may include the information on the transmission beam of the base station 610. For example, the terminal 620 may transmit the information on the index (e.g., index of the best transmission beam) of the transmission beam of the base station 610 and/or the information (e.g., RSRP) on the quality of the corresponding beam to the base station 610. The information on the quality of the beam may include at least one of the information on the RSRP, the RSRQ, the SNR, the SINR, and the like.

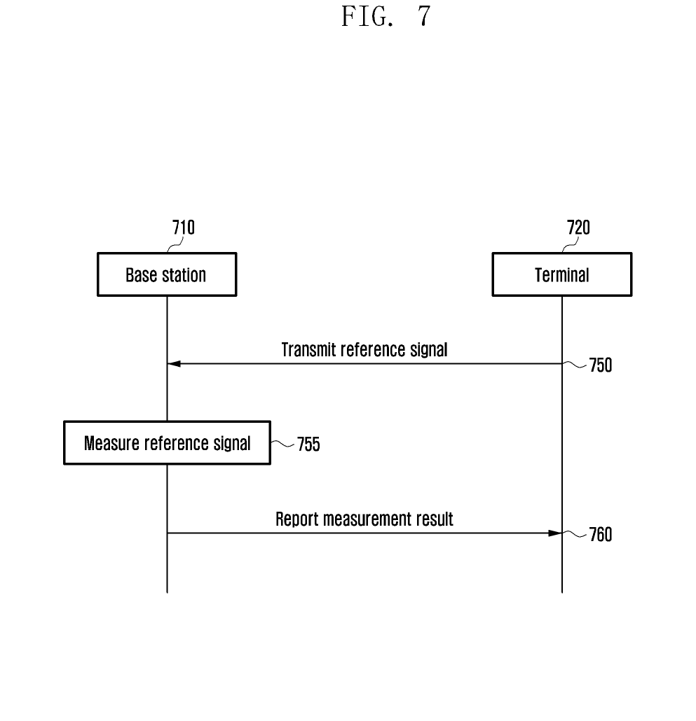

FIG. 7 is a diagram illustrating a UL beam management procedure according to an embodiment of the disclosure.

Referring to FIG. 7, the wireless communication system may include a base station 710 and a terminal 720.

In operation 750, the terminal 720 may transmit the reference signal to the base station 710. As illustrated in FIG. 2, the terminal 720 may perform the beam sweep based on the number of transmission beams and the number of reception beams. To this end, the reference signal may be transmitted from each transmission beam.

In operation 755, the base station 710 may measure the reference signal transmitted by the terminal 720. The base station 710 may sweep its own reception beam and measure the reference signal with respect to the reference signal that the terminal 720 transmits by performing the beam sweep. The operation of the beam sweep is described with reference to FIG. 2. Through the reference signal measurement, the base station 710 may identify the transmission beam of the terminal 720. Also, the base station 710 may identify the reception beam of the base station 710 corresponding to the transmission beam of the terminal 720 by measuring the reference signal. For example, the base station 710 may identify a best transmission beam of the terminal 720, and the base station 710 may identify its own best reception beam corresponding to the best transmission beam of the terminal 720.

In operation 760, the base station 710 may transmit the measurement result to the terminal 720. The measurement result may include the information on the transmission beam of the terminal 720. For example, the base station 710 may transmit the information on the index (e.g., index of the best transmission beam) of the transmission beam of the terminal 720 and/or the information (e.g., RSRP) on the quality of the corresponding beam to the terminal 720. The information on the quality of the beam may include at least one of the information on the RSRP, the RSRQ, the SNR, the SINR, and the like.

Next, the method for beam management will be described based on the determination result of the BC. The beam management may correspond to the operation 375 of FIG. 3 and/or the operation 585 of FIG. 5. Basically, it is assumed that the downlink beam management is performed, and how to perform the uplink beam management according to whether the BC is established will be described. However, the scope of the disclosure is not limited thereto. Therefore, the opposite case is also possible. The opposite case basically means that the uplink beam management is performed and the downlink beam management is operated according to whether the BC is established. In the beam management, it is necessary to consider the case in which an error occurs in the determination on whether the BC is established or the case in which the establishment of the BC is changed.

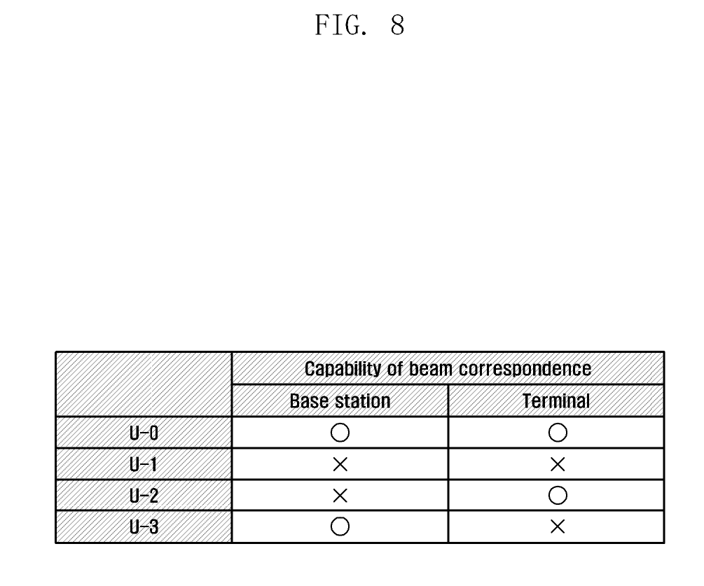

FIG. 8 is a diagram illustrating the number of cases indicating whether the BC is established according to an embodiment of the disclosure. First, the number of cases indicating whether the BC is established will be described with reference to FIG. 8.

Referring to FIG. 8, U-0 is a case in which the BC is established in the base station and the BC is established in the terminal. That is, this is the case in which the reciprocal BC is established. In this case, beam management mode 1 described below may be applied. When the reciprocal BC is established, the beam management operation may not be performed in the uplink. The operation of not performing the beam management operation means a procedure of transmitting, by the terminal, the reference signal while the terminal sweeping the transmission beam and identifying, by the base station, the transmission beam of the terminal and the reception beam of the base station to be used for communication while the base station sweeping the reception beam.

U-1, U-2, and U-3 are cases in which the BC is not established in at least one of the base station and the terminal. That is, this is the case in which the reciprocal BC is not established. The U-1 is the case in which the BC is not established in both the base station and the terminal, and the U-2 is the case in which the BC is not established in the base station but the BC is established in the terminal. The U-3 is the case in which the BC is not established in the terminal but the BC is established in the base station.

When the reciprocal BC is not established, beam management mode 2 described below may be applied. When the reciprocal BC is not established, the uplink beam management operation may be performed. If the reciprocal BC is not established and thus the uplink beam management operation is performed, the detailed operation of the uplink beam management may be changed depending on the U-1, the U-2, and the U-3

In the operation 370 of FIG. 3 and/or the operation 580 of FIG. 5, the base station may transmit the reciprocal BC determination result to the terminal. The reciprocal BC determination result may be transmitted from the base station to the terminal through the DCI or the MAC CE. The reciprocal BC determination result may be on/off information indicating whether the reciprocal BC is established as 1-bit information, and may indicate the U-0, the U-1, and the U-2 as 2-bit information. For example, in 2-bit information, 00 may correspond to the U-0, 01 may correspond to the U-1, 10 may correspond to the U-2, and 11 may correspond to the U-3. On the other hand, the base station does not notify the terminal of the U-0, the U-1, the U-2, and the U-3 as the BC determination result but may indicate whether the terminal should sweep the uplink beam in the uplink beam management operation. That is, the base station may determine the sweep operation for its own reception beam whether it corresponds to the U-0, the U-1, the U-2, and the U-3 and may indicate whether to sweep the transmission beam to the terminal. In the case of corresponding to the U-1 or the U-3, the base station may instruct the terminal to sweep the uplink beam, and in the case of corresponding to the U-2, the base station may instruct the terminal to use the fixed beam without sweeping the uplink beam. In addition, in the case of corresponding to the U-0, the scheduling for the terminal for performing the uplink beam management operation may not be performed because the uplink beam management operation is not performed.

After sharing the reciprocal BC determination and the determination result, the terminal and the base station may be operated in mode 1 or mode 2 as follows.

Mode 1: Operation when Reciprocal BC is Established

The uplink beam management may be omitted when the BC is established in both of the base station and the terminal. In this case, the terminal and the base station may determine the beam that should have been searched through the uplink beam management based on the transmission beam and the reception beam of each node searched by the downlink beam management. That is, the reception beam corresponding to the transmission beam of the base station searched by the downlink beam management operation may be determined as the reception beam of the base station, and the transmission beam corresponding to the reception beam of the terminal searched by the downlink beam management may be determined as the transmission beam of the terminal. By doing so, it is possible to determine the reception beam of the base station and the transmission beam of the terminal that should have been searched by the uplink beam management operation without performing the uplink beam management operation.

In the case 1, since it may be different whether the BC is established which is previously determined and whether the actual BC is established when the reciprocal BC is established to operate the mode 1, the beam operation method for preparing for this is required. Therefore, if the reciprocal BC is established, the uplink beam management is not performed, or if the predetermined situation occurs, the uplink beam management may be performed. For example, the base station may check the quality of the uplink, and may perform the uplink beam management operation if the quality of the uplink is less than a predetermined quality. In addition, when the base station and the terminal are disconnected and then reconnected, the base station may perform the uplink beam management operation. The base station may use the channel quality, the channel state information (CSI), the SINR, the block error rate (BLER), and the like based on the reference signal (e.g., SRS, UL DMRS and the like) that the terminal transmits.

In the case 2, even when the reciprocal BC is established and the mode 1 is operated, the base station may check the uplink quality and perform the uplink beam management operation when the uplink quality is less than the predetermined quality.

Mode 2: When the Reciprocal BC is not Established

The mode 2 may be divided into three cases of the U-1, the U-2, and the U-3, and the base station and the terminal may perform different operations according to each case.

If the reciprocal BC is not established in at least one of the base station and the terminal, the base station performs both of the downlink beam management operation and the uplink beam management operation. When the reciprocal BC is established, the reception beam corresponding to the transmission beam of the base station identified by the downlink beam management operation may be selected as the reception beam of the base station, and the transmission beam corresponding to the reception beam of the terminal identified by the downlink beam management operation may be identified as the transmission beam of the terminal, but it is not impossible when the BC is not established. Therefore, if the reciprocal BC is not established, the base station should perform the uplink management operation.

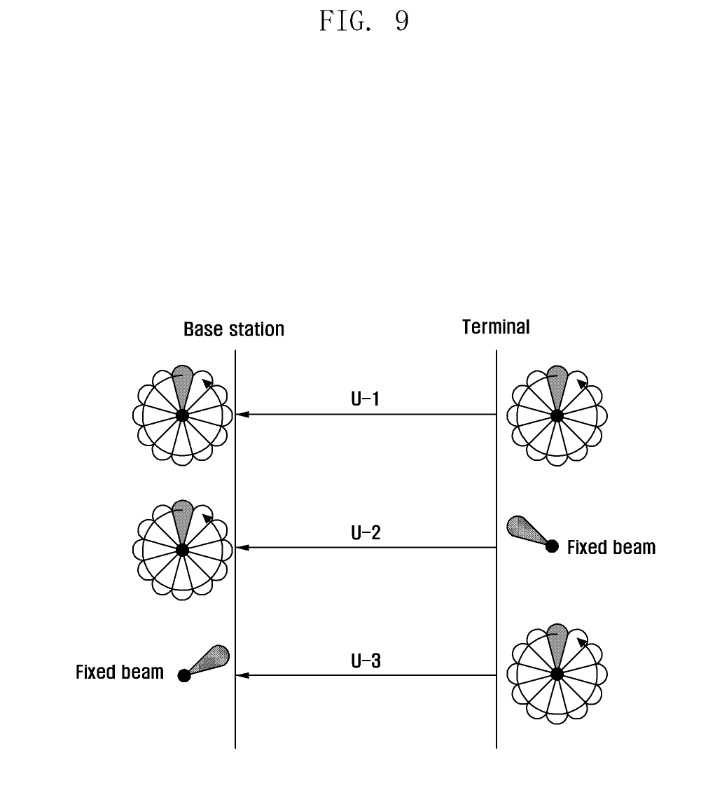

In the mode 2, the uplink beam management operation and the beam search operation are as illustrated in FIG. 9.

FIG. 9 is a diagram illustrating an uplink beam searching method according to the embodiment of the disclosure.

Referring to FIG. 9, the U-1 is the case in which the BC is not established in both of the base station and the terminal. In this case, both of the terminal and the base station sweep the beam in the uplink beam management operation and perform the uplink beam management operation. The terminal transmits the reference signal while sweeping the transmission beam. The base station measures the reference signal while sweeping the reception beam. The base station may select the beam identified by the uplink beam management operation as the reception beam, and the terminal may select the beam identified by the uplink beam management operation as the transmission beam.

The U-2 is the case in which the BC is not established in the terminal but the BC is established in the base station. Since the BC is established in the terminal, the terminal may use the fixed beam. That is, the terminal may perform the uplink beam management operation using the transmission beam corresponding to the reception beam of the terminal identified by the downlink beam management operation as the fixed beam. The base station measures the reference signal transmitted by the terminal while sweeping the reception beam. The base station may select the beam identified by the uplink management operation as the reception beam. Since the terminal selects the fixed transmission beam in advance according to the establishment of the BC, the additional transmission beam selection operation may not be performed according to the uplink beam management operation.

The U-3 is the case in which the BC is not established in the terminal but the BC is established in the base station. Since the BC is established in the base station, the base station may use the fixed reception beam. That is, the base station may perform the uplink beam management operation using the reception beam corresponding to the reception beam of the base station identified by the downlink beam management operation as the fixed beam. The terminal may transmit the reference signal while sweeping the transmission beam. The base station may measure the reference signal transmitted while the terminal sweeps using the fixed beam. The terminal may select the beam identified by the uplink management operation as the transmission beam of the terminal. Since the base station selects the fixed transmission beam in advance according to the establishment of the BC, the additional reception beam selection operation may not be performed according to the uplink beam management operation.

By the above-described method, according to the embodiment of the disclosure, the U-0, the U-1, the U-2, and the U-3 may be generated according to whether the BC is established, and in each case, the uplink beam management operation may not be performed or may be differently performed to improve the communication efficiency.

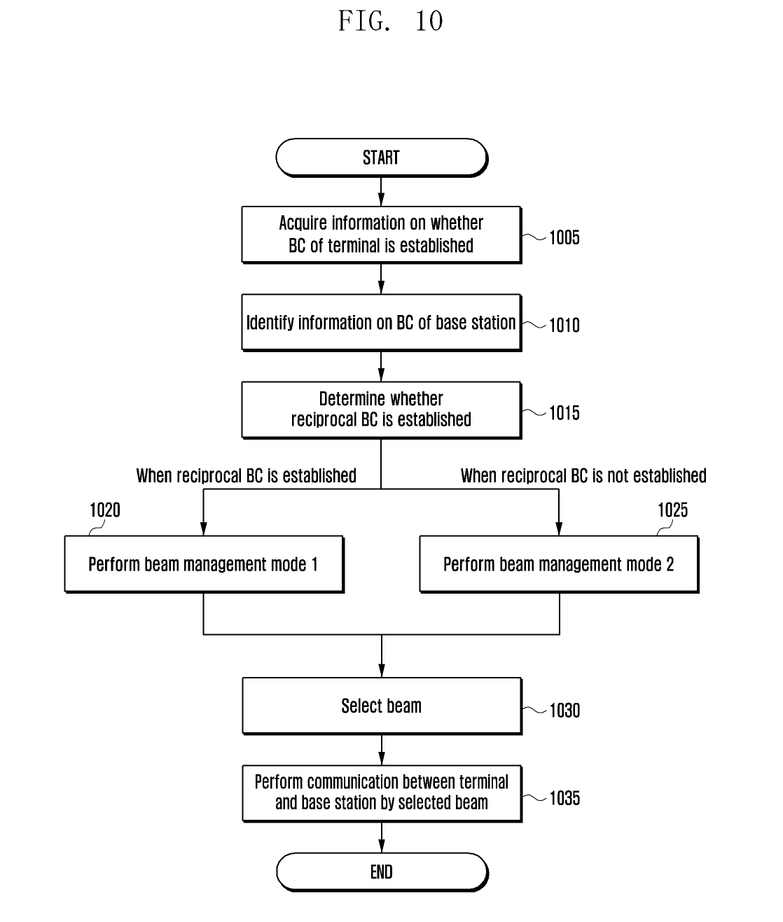

FIG. 10 is a diagram illustrating an operation of a base station according to an embodiment of the disclosure.

Referring to FIG. 10, in operation 1005, the base station may acquire information on the establishment of the BC of the terminal from the terminal. Operation 1005 may include the operation 360, and may include the operation 570 of FIG. 5. The specific process refers to the operations 355 to 360 of FIG. 3 and/or the operations 550 to 570 of FIG. 5.

In the operation 1010, the base station may identify the information on its own BC. The operation 1010 may correspond to the operation 350 of FIG. 3, and may correspond to a process of identifying whether the BC of the base station itself is established prior to determining whether the reciprocal BC is established in FIG. 5.

On the other hand, the order of the operations 1005 and 1010 is exchangeable. Also, if the information to be acquired in the operation 1005 or the operation 1010 operation is already obtained in the base station, the operation for reacquiring the acquired information may be omitted.

In operation 1015, the base station may determine whether the reciprocal BC is established. The base station may determine whether the BC is established based on the information on whether the BC of the terminal acquired in the operations 1005 and 1010 is established and whether the BC of the base station is established. When the BC is established in the base station and the BC is established in the terminal, the reciprocal BC may be established. When the BC is not established in at least one of the base station and the terminal, the reciprocal BC is not established. The operation 1015 may include the operation 365 of FIG. 3, and may include the operation 575 of FIG. 5.

The base station performs the operations 1020 to 1025 based on the determination result of the reciprocal BC in the operation 1005.

If it is determined that the reciprocal BC is established, it proceeds to the operation 1020 to perform the operation corresponding to the beam management mode 1. The beam management mode 1 is the case corresponding to the U-0 among the cases in which the BC is established. Since the reciprocal BC is established, the base station has no reason to search for and select the beam through additional beam management. If the base station performs the downlink beam management, since the reception beam of the base station and the transmission beam of the terminal corresponding to the transmission beam of the base station and the reception beam of the terminal selected by the downlink beam management may be identified, the uplink beam management operation for identifying and selecting the reception beam of the base station and the transmission beam of the terminal may be omitted. On the other hand, when the base station performs the downlink beam management of the terminal, since the transmission beam of the base station and the reception beam of the terminal corresponding to the reception beam of the base station and the transmission beam of the terminal selected by the uplink beam management may be identified, the downlink beam management operation for identifying and selecting the transmission beam of the base station and the reception beam of the terminal may be omitted. The specific operation refers to the operation of the U-0 in FIGS. 8 and 9.

If it is determined that the reciprocal BC is not established, it proceeds to the operation 1025 to perform the operation corresponding to the beam management mode 2. The beam management mode 2 is the case corresponding to one of the U-1, the U-2, and the U-3 among the cases in which the BC is established. Since the reciprocal BC is not established, the base station should search for and select the beam through the additional beam management. If it is assumed that the base station is performing the downlink beam management, when it corresponds to the U-1, the base station and the terminal perform the additional uplink beam management operation. The base station may sweep the reception beam and the terminal may sweep the transmission beam, such that the uplink beam management operation may be performed. If it is assumed that the base station is performing the downlink beam management, when it corresponds to the U-2, the base station and the terminal perform the additional uplink beam management operation. The base station may sweep the reception beam and the terminal may fix the transmission beam, such that the uplink beam management operation may be performed. However, it does not limit the transmission beam fixing of the terminal. If it is assumed that the base station is performing the downlink beam management, when it corresponds to the U-3, the base station and the terminal should perform the additional uplink beam management operation. The base station may fix the reception beam and the terminal may sweep the transmission beam, such that the uplink beam management operation may be performed. The reception beam fixing of the base station is not limited. The specific operation refers to the operations for the U-1, the U-2, and the U-3 of FIGS. 8 and 9. On the other hand, the operation of the case in which the reciprocal BC is not established should not be performed by being necessarily divided into the U-1, the U-2, and the U-3. However, if the reciprocal BC is not established, it is necessary to perform the additional uplink beam management operation.

The beam management operation may end by the above process. In the case in which the base station selects the beam based on the beam management operation to perform communication, the following operations may be additionally performed.

In operation 1030, the base station may select the beam. The base station may identify the transmission beam and the reception beam for communication with the terminal and select the identified beams if necessary. The terminal may identify the transmission beam and the reception beam for communication with the base station and select the identified beams if necessary.

In operation 1035, the terminal and the base station may perform the communication using the selected beam. For example, the time of applying the selected beam may be after a predetermined time has elapsed since the beam exchange indication. The base station may transmit the information on a preset time to the terminal using the RRC message.

In the meantime, the operation of the base station in the embodiment of the disclosure is not limited to the configuration of FIG. 10, and may include all operations of the base station described with reference to FIGS. 1 to 10.

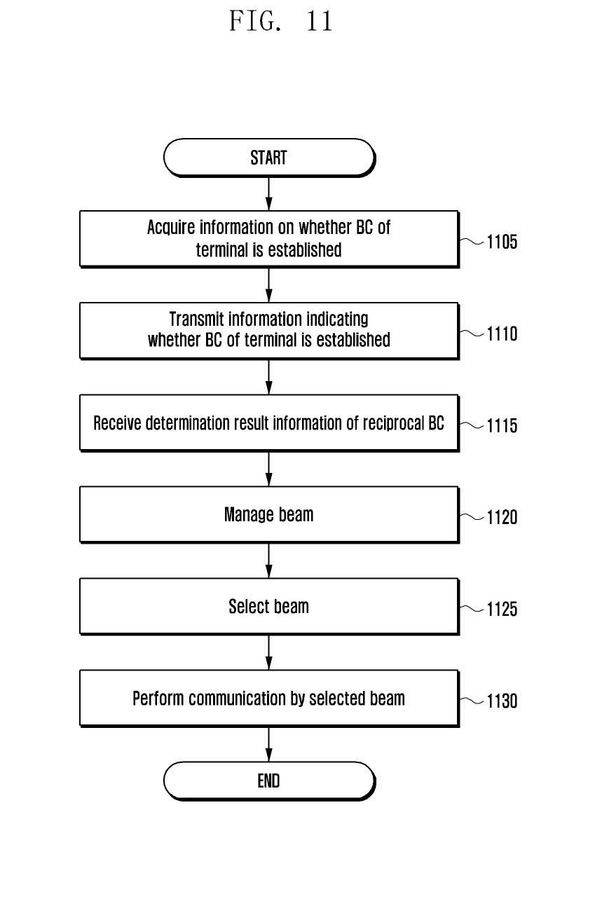

FIG. 11 is a diagram illustrating an operation of a terminal according to an embodiment of the disclosure.

Referring to FIG. 11, in operation 1105, the terminal may acquire the information on whether its own BC is established. The terminal may acquire information on whether the BC is established from the operation 355 of FIG. 3 and may acquire the information on whether the BC is established from the operations 550 to 560 of FIG. 5.

In operation 1110, the terminal may provide the base station with the information on whether the acquired its own BC is established. If the information is acquired from the operation 355 of FIG. 3, like the operation 360 of FIG. 3, the information on whether the BC is established may be provided to the base station. If the information is received from the operations 550 to 560 of FIG. 5, when there is a request from the base station, like the operation 570 of FIG. 5, the information on whether the BC is established may be provided to the base station.

In operation 1115, the terminal may receive the information on the determination result of the reciprocal BC from the base station. That is, since the terminal knows whether its own BC is established, it may receive the information on whether the BC of the base station is established. Alternatively, the information indicating at least one of the U-0, the U-1, the U-2, and the U-3 mentioned in FIG. 8 may be received.

The information on the determination result may be the information indicating the specific operation to the terminal. If the terminal is performing the periodic or aperiodic downlink beam management operation, the determination result of the reciprocal BC may be information indicating whether to perform the uplink beam management operation. If it corresponds to the U-0, it may be information on an indication not to perform the uplink beam management operation, and if it corresponds to the U-1, the U-2, and the U-3, it may be information on an indication to perform the uplink beam management operation. If it corresponds to the U-1 or the U-3, it may be information on an indication to sweep the beam and perform the uplink beam management operation, and if it is the U-2, it may perform an indication to fix the beam and perform the uplink beam management operation.

By the method as described above, the terminal may perform the uplink management operation based on the BC determination result. On the contrary, if the terminal is performing the uplink beam management operation periodically or non-periodically, the terminal may determine whether to perform the downlink beam management additionally according to the BC determination result. At this time, it may receive the indication on whether to sweep or fix the downlink reception beam. The specific operation of the beam management refers to the specific operation of FIGS. 8 and 9.

The beam management operation (e.g., operation 1120) may end by the above process. In the case in which the terminal selects the beam based on the beam management operation to perform communication, the following operations may be additionally performed.

In operation 1125, the terminal may select the beam. The terminal may identify the transmission beam and the reception beam for communication with the base station and select the identified beams if necessary. The base station may identify the transmission beam and the reception beam for communication with the terminal and select the identified beams if necessary.

In operation 1130, the terminal and the base station may perform the communication using the selected beam. For example, the time of applying the selected beam may be after a predetermined time has elapsed since the beam exchange indication. The terminal may receive the information on the preset time from the base station using the RRC message.

In the meantime, the operation of the terminal in the embodiment of the disclosure is not limited to the configuration of FIG. 11, and may include all operations of the terminal described with reference to FIGS. 1 to 11.

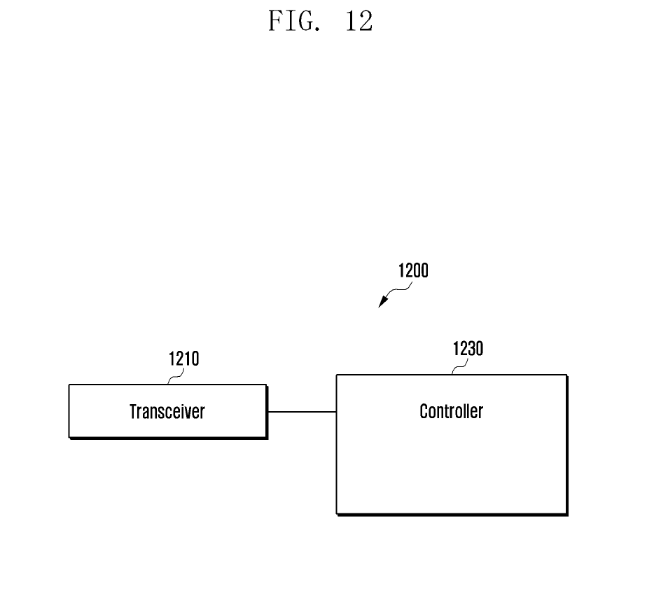

FIG. 12 is a diagram illustrating a base station according to an embodiment of the disclosure.

Referring to FIG. 12, the terminal 1200 may include a transceiver 1210 for transmitting and receiving a signal and a controller 1230. The base station 1200 may transmit and/or receive a signal, information, message and the like through the transceiver 1210. The controller 1230 may control the overall operation of the base station 1200. The controller 1230 may include at least one processor. The controller 1230 may control the operation of the base station described with reference to FIGS. 1 to 11.

According to the embodiment of the disclosure, the controller 1230 may perform a control to receive the information on whether the beam correspondence (BC) of the terminal is established, identify the information on whether the BC of the base station is established, determine whether the reciprocal BC is established based on the information on whether the BC of the terminal is established or the information on whether the BC of the base station is established, and determine whether to perform the uplink beam management operation based on whether the reciprocal BC is established. The establishment of the BC of the terminal includes the case in which the reception beam of the terminal corresponds to the transmission beam of the terminal and vice versa. The establishment of the BC of the base station includes the case in which the transmission beam of the base station corresponds to the reception beam of the base station, and vice versa. The establishment of the reciprocal BC includes the case in which the BC of the terminal and the BC of the base station are simultaneously established.

Also, the controller 1230 may perform a control not to perform the uplink beam management operation when the reciprocal BC is established. Also, the controller 1230 may perform a control to perform the uplink beam management operation when the reciprocal BC is established.

In addition, when performing the uplink beam management operation, the controller 1230 may control the node at which the BC is established among the terminal and the base station to use the fixed beam and the node at which the BC is not established to sweep the beam.

The establishment of the BC of the terminal and the base station may be determined based on at least one of the beam index and the beam quality. The beam quality may include comparing the first quality information normalized by the transmit power of the base station with the second quality information normalized by the transmit power of the terminal.

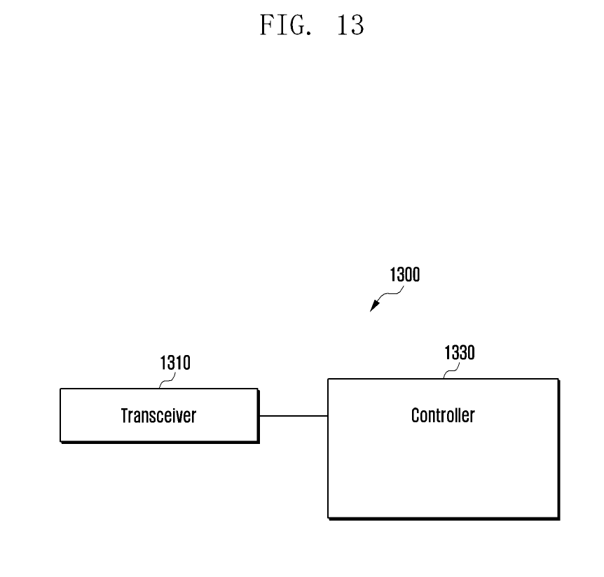

FIG. 13 is a diagram illustrating a terminal according to an embodiment of the disclosure.

Referring to FIG. 13, the terminal 1300 may include a transceiver 1310 for transmitting and receiving a signal and a controller 1330. The terminal 1300 may transmit and/or receive a signal, information, message and the like through the transceiver 1310. The controller 1330 may control the overall operation of the terminal 1300. The controller 1330 may include at least one processor. The controller 1330 may control the operation of the terminal described with reference to FIGS. 1 to 11.

According to the embodiment of the disclosure, the controller 1330 may perform a control to acquire the information on whether the beam correspondence (BC) of the terminal is established, transmit the information on whether the BC of the terminal is established to the base station, receive the information on whether the reciprocal BC is established from the base station, and determine whether to perform the uplink beam management operation based on the information on whether the reciprocal BC is established.

The establishment of the BC of the terminal includes the case in which the reception beam of the terminal corresponds to the transmission beam of the terminal and vice versa. The establishment of the BC of the base station includes the case in which the transmission beam of the base station corresponds to the reception beam of the base station, and vice versa. The establishment of the reciprocal BC includes the case in which the BC of the terminal and the BC of the base station are simultaneously established.

If the reciprocal BC is established, the controller 1330 may perform a control not to perform the uplink beam management operation, and if the reciprocal BC is not established, the controller 1330 may perform a control to perform the uplink beam management operation.

In addition, when performing the uplink beam management operation, the controller 1330 may control the node at which the BC is established among the terminal and the base station to use the fixed beam and the node at which the BC is not established to sweep the beam.

The establishment of the BC of the terminal and the base station may be determined based on at least one of the beam index and the beam quality. The beam quality may include comparing the first quality information normalized by the transmit power of the base station with the second quality information normalized by the transmit power of the terminal.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for beam management of a base station, the method comprising:
receiving information on whether beam correspondence (BC) of a terminal is established;
identifying information on whether BC of the base station is established;
determining whether reciprocal BC is established based on the information on whether the BC of the terminal is established and the information whether the BC of the base station is established; and
determining whether to perform an uplink beam management operation based on whether the reciprocal BC is established.

2. The method of claim 1,
wherein the establishment of the BC of the terminal includes a case in which a reception beam of the terminal corresponds to a transmission beam of the terminal,
wherein the establishment of the BC of the base station includes a case in which a transmission beam of the base station corresponds to a reception beam of the base station, and
wherein the establishment of the reciprocal BC includes a case in which the BC of the terminal and the BC of the base station are simultaneously established.

3. The method of claim 1, wherein, if the reciprocal BC is established, the uplink beam management operation is not performed.

4. The method of claim 1, further comprising:
performing the uplink beam management operation if the reciprocal BC is not established.

5. The method of claim 4, wherein, when the uplink beam management operation is performed, among the terminal and the base station, a node at which the BC is established uses a fixed beam and a node at which the BC is not established sweeps a beam.

6. The method of claim 1, wherein the establishment of the BC of the terminal is determined based on at least one of a beam index or a beam quality.

7. The method of claim 6, wherein the beam quality may be determined by comparing first quality information normalized by transmit power of the base station with second quality information normalized by transmit power of the terminal.

8. A base station comprising:
a transceiver configured to transmit and receive a signal; and
at least one processor configured to:
receive information on whether beam correspondence (BC) of a terminal is established,
identify information on whether BC of the base station is established,
determine whether reciprocal BC is established based on the information on whether the BC of the terminal is established and the information on whether the BC of the base station is established, and
determine whether to perform the uplink beam management operation based on whether the reciprocal BC is established.

9. The base station of claim 8,
wherein the establishment of the BC of the terminal includes a case in which a reception beam of the terminal corresponds to a transmission beam of the terminal,
wherein the establishment of the BC of the base station includes a case in which a transmission beam of the base station corresponds to a reception beam of the base station, and
wherein the establishment of the reciprocal BC includes a case in which the BC of the terminal and the BC of the base station are simultaneously established.

10. The base station of claim 8, wherein, if the reciprocal BC is established, the at least one processor is further configured to perform a control not to perform the uplink beam management operation.

11. The base station of claim 8, wherein, if the reciprocal BC is not established, the at least one processor is further configured to perform a control to perform the uplink beam management operation.

12. The base station of claim 11, wherein, when the uplink beam management operation is performed, the at least one processor is further configured to control a node at which the BC is established among the terminal and the base station to use a fixed beam and a node at which the BC is not established to sweep a beam.

13. The base station of claim 8, wherein the establishment of the BC of the terminal is determined based on at least one of a beam index or a beam quality.

14. The base station of claim 13, wherein the beam quality may be determined by comparing first quality information normalized by transmit power of the base station with second quality information normalized by transmit power of the terminal.

15. A method for beam management of a terminal, the method comprising:
acquiring information on whether beam correspondence (BC) of the terminal is established;
transmitting information on whether the BC of the terminal is established to a base station;
receiving information on whether reciprocal BC is established from the base station; and
determining whether to perform an uplink beam management operation based on the information on whether the reciprocal BC is established.

16. The method of claim 15,
wherein the establishment of the BC of the terminal includes a case in which a reception beam of the terminal corresponds to a transmission beam of the terminal,
wherein the establishment of the BC of the base station includes a case in which a transmission beam of the base station corresponds to a reception beam of the base station, and
wherein the establishment of the reciprocal BC includes a case in which the BC of the terminal and the BC of the base station are simultaneously established.

17. The method of claim 15,
wherein, if the reciprocal BC is established, the uplink beam management operation is not performed, and
wherein, if the reciprocal BC is not established, the uplink beam management operation is performed.

18. A terminal comprising:
a transceiver configured to transmit and receive a signal; and
at least one processor configured to:
acquire information on whether beam correspondence (BC) of the terminal is established,
transmit the information on whether the BC of the terminal is established to a base station,
receive information on whether reciprocal BC is established from the base station, and
determine whether to perform an uplink beam management operation based on the information on whether the reciprocal BC is established.

19. The terminal of claim 18,
wherein the establishment of the BC of the terminal includes a case in which a reception beam of the terminal corresponds to a transmission beam of the terminal,
wherein the establishment of the BC of the base station includes a case in which a transmission beam of the base station corresponds to a reception beam of the base station, and
wherein the establishment of the reciprocal BC includes a case in which the BC of the terminal and the BC of the base station are simultaneously established.

20. The terminal of claim 18,
wherein, if the reciprocal BC is established, the uplink beam management operation is not performed, and
wherein, if the reciprocal BC is not established, the uplink beam management operation is performed.
